(19) United States
(12) Patent Application Publication
(10) Pub. No.: US 2007/0065636 A1
(43) Pub. Date: Mar. 22, 2007

(54) Article having a birefringent surface and microstructured features having a variable pitch or angles and process for making the article

(76) Inventors: William Ward Merrill, White Bear Lake, MN (US); Rolf W. Biernath, Wyoming, MN (US); Robert L. Brott, Woodbury, MN (US); John S. Huizinga, Dellwood, MN (US); William B. Black, Eagan, MN (US)

Correspondence Address: 3M INNOVATIVE PROPERTIES COMPANY, PO BOX 33427, ST. PAUL, MN, 55133-3427, US

(21) Appl. No.: 11/197,714

(22) Filed: Aug. 4, 2005

(51) Int. Cl. G11B 5/64; B32B 3/00

(52) U.S. Cl. 428/141; 428/156

(57) ABSTRACT

Microstructured features having a variable pitch or angles on a birefringent surface of an article and a process for making it. The article is uniaxial oriented to provide the birefringence. The variable pitch provides for various optical effects and can include a random pitch, aperiodic pitch, quasi-aperiodic pitch, or a combination of them.

### FIELD OF INVENTION

The present invention relates to an article having a birefringent surface with variable pitch or angle microstructures for providing various optical effects, and a process for making the article.

### BACKGROUND

Optical articles having structured surfaces, and processes for providing such articles are known. See for example, U.S. Pat. Nos. 6,096,247 and 6,808,658, and published application U.S. 2002/0154406 A1. The structured surfaces disclosed in these references include microprisms (such as microcubes) and lenses. Typically these structures are created on the surface of a suitable polymer by, for example embossing, extrusion or machining.

Birefringent articles having structured surfaces are also known. See, for example, U.S. Pat. Nos. 3,213,753; 4,446,305; 4,520,189; 4,521,588; 4,525,413; 4,799,131; 5,056,030; 5,175,030 and published applications WO 2003/0058383 A1 and WO 2004/062904 A1.

Processes for manufacturing stretched films are also known. Such processes are typically employed to improve the mechanical and physical properties of the film. These processes include biaxial stretching techniques and uniaxial stretching techniques. See for example PCT WO 00/29197, U.S. Pat. Nos. 2,618,012; 2,988,772; 3,502,766; 3,807,004; 3,890,421; 4,330,499; 4,434,128; 4,349,500; 4,525,317 and 4,853,602. See also U.S. Pat. Nos. 4,862,564; 5,826,314; 5,882,774; 5,962,114 and 5,965,247. See also Japanese Unexamined Patent Publications Hei 5-11114; 5-288931; 5-288932; 6-27321 and 6-34815. Still other Japanese Unexamined Applications that disclose processes for stretching films include Hei 5-241021; 6-51116; 6-51119; and 5-11113. See also WO 2002/096622 A1.

### SUMMARY OF INVENTION

A structured article includes a body having first and second surfaces, and first and second in-plane axes that are orthogonal with respect to each other and a third axis that is mutually orthogonal to the first and second in-plane axes in a thickness direction of the body. A portion of the first surface is a birefringent structured surface having a variable pitch or features with variable angles.

A uniaxially oriented structured article includes a polymeric film having a first and a second surface, and first and second in-plane axes that are orthogonal with respect to each other and a third axis that is mutually orthogonal to the first and second in-plane axis in a thickness direction of the polymeric film. A surface portion of the film has a plurality of geometric features disposed on the first surface of the polymeric film. The plurality of linear geometric features are disposed on the film in a direction substantially parallel to the first in-plane axis of the polymeric film, and they have a variable pitch.

The present invention also includes methods for making the structured articles.

The geometric feature or features replicated may be, for example, either a prismatic, lenticular, or sinusoidal geometric feature. The geometric feature or features may be continuous or discontinuous both widthwise and lengthwise. It may be a macro- or a micro-feature. It may have a variety of cross-sectional profiles as discussed more fully below. The geometric feature may be repeating or non-repeating on the replicated structured surface. The replicated surface may comprise a plurality of geometric features that have the same cross-sectional shape. Alternatively, it may have a plurality of geometric features that have different cross-sectional shapes.

As used herein, the following terms and phrases have the following meaning.

“Birefringent surface” means a surface portion of a body proximate a birefringent material in the body.

“Cross-sectional shape”, and obvious variations thereof, means the configuration of the periphery of the geometric feature defined by the second in-plane axis and the third axis. The cross-sectional shape of the geometric feature is independent of its physical dimension. “Dispersion” means the variation of refractive index with wavelength. Dispersion may vary along different axes differently in an anisotropic material.

“Stretch ratio”, and obvious variations thereof, means the ratio of the distance between two points separated along a direction of stretch after stretching to the distance between the corresponding points prior to stretching.

“Geometric feature”, and obvious variations thereof, means the predetermined shape or shapes present on the structured surface.

“Macro” is used as a prefix and means that the term that it modifies has a cross-sectional profile that has a height of greater than 1 mm.

“Pitch” for a array of periodic structures means the distance, measured parallel to the second in-plane axis, between succeeding peaks or succeeding valleys as projected onto a common film body plane. Pitch, for an array of variable structures, means the distance, measured parallel to the second in-plane axis, between relative maxima or relative minima of succeeding geometric features.

“Mean pitch” means an average of the distribution of a plurality of pitches.

“Metallic surface” and obvious variations thereof, means a surface coated or formed from a metal or a metal alloy which may also contain a metalloid. “Metal” refers to an element such as iron, gold, aluminum, etc., generally characterized by ductility, malleability, luster, and conductivity of heat and electricity which forms a base with the hydroxyl radical and can replace the hydrogen atom of an acid to form a salt. “Metalloid” refers to nonmetallic elements having some of the properties of a metal and/or forming an alloy with metal (for example, semiconductors) and also includes nonmetallic elements which contain metal and/or metalloid dopants.

“Micro” is used as a prefix and means that the term it modifies has a cross- sectional profile that has a height of 1 mm or less. Preferably the cross-sectional profile has a height of 0.5 mm or less. More preferably the cross-sectional profile is 0.05 mm or less.

“Oriented” means having an anisotropic dielectric tensor with a corresponding anisotropic set of refractive indices.

“Orientation” means a state of being oriented.

“Uniaxial orientation” means that two of the principal refractive indices are substantially the same.

“Uniaxial stretch”, including obvious variations thereof, means the act of grasping opposite edges of an article and physically stretching the article in only one direction. Uniaxial stretch is intended to include slight imperfections in uniform stretching of the film due to, for example, shear effects that can induce momentary or relatively very small biaxial stretching in portions of the film. Truly uniaxial stretching refers to a special sub-set of uniaxial stretching in which the material is relatively unconstrained in the in-plane film direction orthogonal to the stretch direction, resulting in uniaxial orientation.

“Structure surface” means a surface that has at least one geometric feature thereon.

“Structured surface” means a surface that has been created by any technique that imparts a desired geometric feature or plurality of geometric features to a surface.

“Variable angles” means that not all the features on the same article or film sharing a geometrical resemblance in cross section have the same angle of inclination for the corresponding cross-sectional sides of the identifiable features formed between a given side, extended as needed, and the film body plane.

In many particular cases, the feature may resemble, e.g. approximate, simple geometric shapes. For example, in cross-section, the features may resemble simple geometric polygons, such as triangles or quadrilaterals. Such features have discernable sides and vertices. In practice, the sides may be curved or “wiggly” and the vertices may be rounded but the general geometrical shape remains discernable. In many of these cases, an average slope of inclination can be discerned, e.g. by fitting a line through a middle portion of the side that excludes the vagaries introduced by the imperfect or designed rounding at the peak (maximum with respect to film body) and/or valley (minimum with respect to film body) of this side.

Likewise, apex angles for the various vertices may be estimated by extending and connecting such lines representing the two sides bounding and defining each of these vertices. In this context, “variable angles” means that not all the features on the same article or film sharing a geometrical resemblance in cross section have the same angle of inclination for the corresponding cross-sectional sides of the identifiable features formed between a given side, extended as needed, and the film body plane and/or that the various apex angles of the corresponding vertices vary between the features. In other such cases, the middle portion of the side is deliberately designed with a particular curvature, e.g. the curvature of the side proceeds approximately from the valley to the peak along the cross-sectional edge according to an idealized parametric equation. In this context, “variable angles” also includes the variation of parametric starting and ending points on the idealized curve from the valley to peak of the corresponding sides among the various features.

“Wavelength” means the equivalent wavelength measured in a vacuum.

In the case of layered films, “uniaxial” or “truly uniaxial” are intended to apply to individual layers of the film unless otherwise specified.

In terms of pitch:

“aperiodic” means no regular repeating pattern, e.g. the distribution of pitches has no regular or periodic spacing;

“quasi-aperiodic” means that over a defined length scale (which may range from 1 mm to several meters), the collection of surface features has an aperiodic pitch progression; a quasi-aperiodic distribution can be formed by repeating a specific aperiodic pattern over a longer length scale to make a progression of surface features over a much larger scale (e.g. 1 cm to 100 cm to 10 m); and

“random” means no deliberate sequence, except as constrained by a chosen mean and a distribution function.

A random progression of pitches for a film with a collection of surface features can be derived by choosing a mean value for the pitch and a distribution function of allowed values about that mean value. The distribution function can take various forms, e.g a Poisson, a truncated normal distribution (e.g., by choosing upper and lower bounds and re-normalizing) or a uniform distribution. A uniform distribution provides an equal probability for all values between specified upper and lower bounds. For example, the 10% random case of the Examples has a mean pitch and upper and lower bounds of +10% and −10% about that mean. The 100% random case of the Examples has a mean pitch and upper and lower bounds of +100% (i.e., twice the mean value) and −100% (i.e. essentially zero) about that mean. A pseudo-random pattern is often taken as a particular progression derived by choosing the mean and distribution and evolving the progression by realizing successive pitch values using a random or pseudo-random number generator. In the context of this specification, the term random may imply such a pseudo-random sequence.

### BRIEF DESCRIPTION OF THE DRAWINGS

The invention may be more completely understood in the following detailed description of various embodiments of the invention in connection with the accompanying drawings, in which:

FIG. 1 is a sectional view of a film made by one method;

FIGS. 2A-2E are cross-sectional views of some alternative embodiments of an article;

FIGS. 3A-3W illustrate sectional views of some alternative profiles of geometric features that can be made by one method;

FIG. 4 is a schematic representation of one process for making a structured film;

FIG. 5 is a perspective view of a variable pitch microstructured birefringent film;

FIGS. 6A and 6B are side and top views, respectively, of a variable pitch microstructured birefringent film having a constant PS and a variable BW;

FIGS. 7A and 7B are side and top views, respectively, of a variable pitch microstructured birefringent film having a variable PS and a constant BW;

FIGS. 8A and 8B are side and top views, respectively, of a variable pitch microstructured birefringent film having a variable PS and a variable BW;

FIGS. 9A-9C are edge views of scanning electron microscope (SEM) images of an exemplary sample having 10% random pitch;

FIGS. 10A and 10B are top views of SEM images of an exemplary sample having 10% random pitch;

FIGS. 11A-11C are edge views of SEM images of an exemplary sample having 100% random pitch; and

FIGS. 12A and 12B are top views of SEM images of an exemplary sample having 100% random pitch.

The invention is amenable to various modifications and alternative forms. Specifics of the invention are shown in the drawings by way of example only. The intention is not to limit the invention to the particular embodiments described. Instead, the intention is to cover all modifications, equivalents, and alternatives falling within the spirit and scope of the invention.

### DETAILED DESCRIPTION

Microstructured Articles

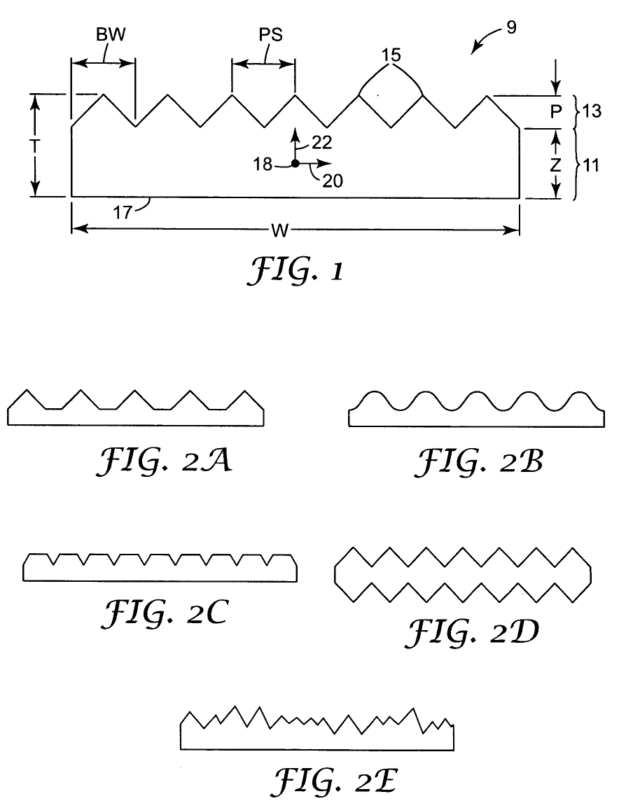

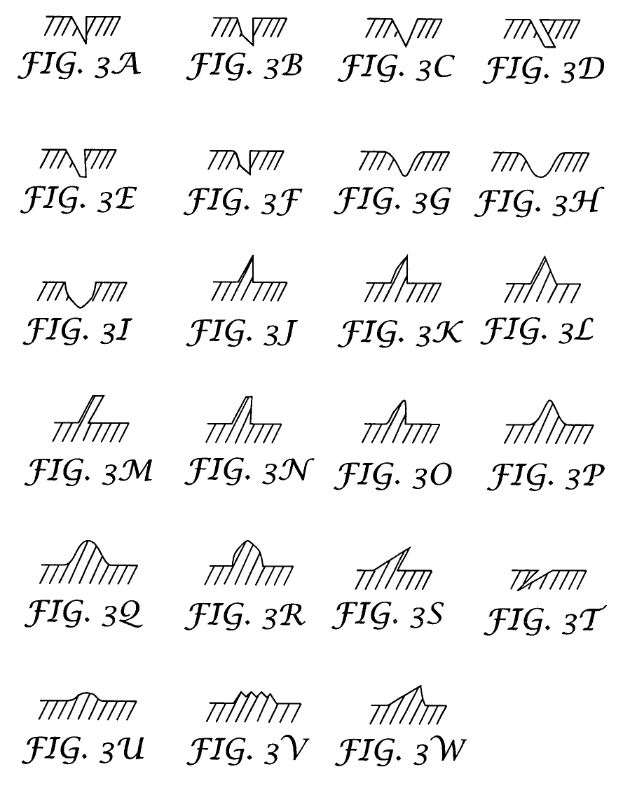

The articles and films made by one exemplary process generally comprise a body portion and a surface structure portion. FIG. 1 represents end views of a film made according to various embodiments. FIGS. 2A-2E illustrate cross-sectional views of some alternative embodiment films that can be made by one particular process. FIGS. 3A-3W illustrate some alternative embodiments of geometric features of articles having structured surfaces.

Referring to FIG. 1, film 9 comprises a body or land portion 11 having a thickness (Z) and a surface portion 13 having a height (P). Surface portions 13 comprises a series of parallel geometric features 15 generally continuous in the groove direction, here shown as right angle prisms. Geometric features 15 each have a basal width (BW) and a peak-to-peak spacing (PS). The film has a total thickness T which is equal to the sum of P+Z. The basal width generally denotes the valley-to-valley spacing between features, for example as projected onto a common plane in the film body.

Body or land portion 11 comprises the portion of the article between bottom surface 17 of the film 9 and the lowest point of the surface portion 13. In some cases, this may be a constant dimension across the width (W) of the article. In other cases, this dimension may vary due to the presence of geometric features having varying peak heights or valley depths. See FIG. 2E.

Film 9 has a first in-plane axis 18, a second in-plane axis 20 and a third axis 22. In FIG. 1, the first in-plane axis 18 is substantially parallel to the length of the geometric feature 15. In FIG. 1, the first in-plane axis is normal to the end of film 9. These three axes are mutually orthogonal with respect to one another.

In general, the film is the result of a stretching process. The film may be unoriented (isotropic), uniaxially oriented, or biaxially oriented. The features may be imparted to the film before or after stretching by a variety of methods. In some instances, uniaxially oriented films are preferred.

Various methods can be used to make a uniaxially oriented film. Uniaxial orientation may be measured by determining the difference in the index of refraction of the film along the first in-plane axis (n₁), the index of refraction along the second in-plane axis (n₂), and the index of refraction along the third axis (n₃). Uniaxially oriented films made by the method can have n₁≠n₂ and n₁≠n₃. Additionally, n₂ and n₃ are substantially the same as one another relative to their differences to n₁. A film preferably made by one particular method can be truly uniaxially oriented.

A method may also be used to provide a film that has a relative birefringence for a wavelength of interest of 0.3 or less. In another embodiment, the relative birefringence is less than 0.2 and in yet another embodiment it is less than 0.1. Relative birefringence is an absolute value determined according to the following expression:
|n₂−n₃|/|n₁−(n₂+n₃)/2|

A method can be used to make films that have at least two prismatic or lenticular geometric features. The geometric feature may be an elongate structure that is typically parallel to the first in-plane axis of the film. As shown in FIG. 1, the structured surface comprises a series of right angle prisms 15. However, other geometric features and combinations thereof may be used. See, for example, FIGS. 2A-2E and FIGS. 3A-3W. FIG. 2A shows that the geometric features do not need to touch each other at their bases. FIG. 2B shows that the geometric features may have rounded peaks and curved facets. FIG. 2C shows that the peaks of the geometric features may be flat. FIG. 2D shows that opposing surfaces of the film each may have a structured surface. FIG. 2E shows that the geometric features may have varying land thicknesses, peak heights, and basal widths.

FIGS. 3A-3W illustrate other cross-sectional shapes that may be used to provide the structured surface. These Figures further illustrate that the geometric feature may comprise a depression (See FIGS. 3A-I and 3T) or a projection (see FIGS. 3J-3S and 3U-W). In the case of features that comprise depressions, the elevated area between depressions may be considered to be a projection-type feature as shown in FIG. 2C.

Various methods may be used to provide various feature embodiments that may be combined in any manner so as to achieve a desired result. For example horizontal surfaces may separate features that have radiused or flat peaks. Moreover curved faces may be used on any of these features.

As can be seen from the Figures, the methods may be used to provide features of any desired geometric shape. They may be symmetric or asymmetric with respect to the z-axis (thickness) of the film. They may comprise a single feature, a plurality of the same feature in a desired pattern, or a combination of two or more features arranged in a desired pattern. Additionally, the dimensions, such as height and/or width, of the features may be the same across the structured surface. Alternatively, they may vary from feature to feature.

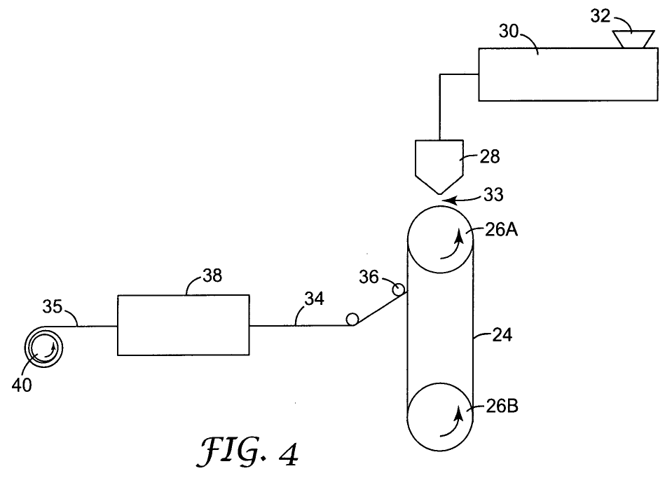

One process of making a structured article includes providing a polymeric resin that is capable of having a desired structured surface imparted to it by embossing, casting, extrusion or other non-machining techniques, which involve no cutting or other shaping of a solid material; rather, a flow mechanism of a fluid or visco-elastic material is shaped through the process then fixed into a solid. The structured surface may either be provided concurrently with the formation of the desired article or it may be imparted to a first surface of the resin after the article has been formed. The process will be further explained with regard to FIG. 4.

FIG. 4 is a schematic representation of one method of making a film with a structured surface. In the method, a tool 24 comprising a negative version of the desired structured surface of the film is provided and is advanced by means of drive rolls 26A and 26B past an orifice (not shown) of die 28. Die 28 comprises the discharge point of a melt train, here comprising an extruder 30 having a feed hopper 32 for receiving dry polymeric resin in the form of pellets, powder, etc. Molten resin exits die 28 onto tool 24. A gap 33 is provided between die 28 and tool 24. The molten resin contacts the tool 24 and hardens to form a polymeric film 34. The leading edge of the film 34 is then stripped from the tool 24 at stripper roll 36. Subsequently, film 34 may be directed to stretching apparatus 38 if desired at this point. The film 34 may then be wound into a continuous roll at station 40.

A variety of techniques may be used to impart a structured surface to the film. These include batch and continuous techniques. They involve providing a tool having a surface that is a negative of the desired structured surface; contacting at least one surface of the polymeric film to the tool for a time and under conditions sufficient to create a positive version of the desired structured surface to the polymer; and removing the polymer with the structured surface from the tool. Typically the negative surface of the tool comprises a metallic surface, frequently with a release agent applied.

Although the die 28 and tool 24 are depicted in a vertical arrangement with respect to one another, horizontal or other arrangements may also be employed. Regardless of the particular arrangement, the die 28 provides the molten resin to the tool 24 at the gap 33.

The die 28 is mounted in a manner that permits it to be moved toward the tool 24. This allows one to adjust the gap 33 to a desired spacing. The size of the gap 33 is a function of the composition of the molten resin, its viscosity and the pressure necessary to essentially completely fill the tool with the molten resin.

The molten resin is of a viscosity such that it preferably substantially fills, optionally with applied vacuum, pressure, temperature, ultrasonic vibration or mechanical means, into the cavities of the tool 24. When the resin substantially fills the cavities of the tool 24, the resulting structured surface of the film is said to be replicated.

In the case that the resin is a thermoplastic resin, it is typically supplied as a solid to the feed hopper 32. Sufficient heat is provided by the extruder 30 to convert the solid resin to a molten mass. The tool is typically heated by passing it over a heated drive roll 26A. Drive roll 26A may be heated by, for example circulating hot oil through it or by inductively heating it. The temperature of the tool 24 at roll 26A is typically above the softening point of the resin but below its decomposition temperature.

In the case of a polymerizable resin, including a partially polymerized resin, the resin may be poured or pumped directly into a dispenser that feeds the die 28. If the resin is a reactive resin, the method can include one or more additional steps of curing the resin. For example, the resin may be cured by exposure to a suitable radiant energy source such as actinic radiation, for example ultraviolet light, infrared radiation, electron beam radiation, visible light, etc., for a time sufficient to harden the resin and remove it from the tool 24.

The molten film can be cooled by a variety of methods to harden the film for further processing. These methods include spraying water onto the extruded resin, contacting the unstructured surface of the tool with cooling rolls, or direct impingement of the film and/or tool with air.

The previous discussion was focused on the simultaneous formation of the film first surface of a preformed film. Pressure, heat, or pressure and heat are then applied to the film/tool combination until the surface of the film has softened sufficiently to create the desired structured surface in the film. Preferably, the surface of the film is softened sufficiently to completely fill the cavities in the tool. Subsequently, the film is cooled and removed from the master.

As noted previously, the tool comprises a negative version (i.e., the negative surface) of the desired structured surface. Thus, it comprises projections and depressions (or cavities) in a predetermined pattern. The negative surface of the tool can be contacted with the resin so as to create the geometric features on the structured surface in any alignment with respect to the first or second in-plane axes. Thus, for example, the geometric features of FIG. 1 may be aligned with either the machine, or length, direction, or the transverse, or width, direction of the article.

In one embodiment of the replication step, the cavities of the tool are at least 50% filled by the resin. In another embodiment, the cavities are at least 75% filled by the resin. In yet another embodiment, the cavities are at least 90% filled by the resin. In still another embodiment, the cavities are at least 95% filled by the resin. In another embodiment, the cavities are at least 98% filled by the resin.

Adequate fidelity to the negative may be achieved for many applications when the cavities are filled to at least 75% by the resin. However, better fidelity to the negative is achieved when the cavities are filled to at least 90% by the resin. The best fidelity to the negative is achieved when the cavities are filled to at least 98% by the resin.

The tool used to create the desired structured surface may have a coating comprising a fluorochemical benzotriazole on the negative surface. The presence of the fluorochemical is preferred; some polymers do not require that the fluorochemical be used while others do. The fluorochemical benzotriazole preferably forms a substantially continuous monolayer film on the tool. The phrase “substantially continuous monolayer film” means that the individual molecules pack together as densely as their molecular structures allow. It is believed that the films self assemble in that the triazole groups of the molecules attach to available areas of the metal/metalloid surface of the tool and that the pendant fluorocarbon tails are aligned substantially towards the external interface.

The effectiveness of a monolayer film and the degree to which a monolayer film is formed on a surface is generally dependent upon the strength of the bond between the compound and the particular metal or metalloid surface of the tool and the conditions under which the film-coated surface is used. For example, some metal or metalloid surfaces may require a highly tenacious monolayer film while other such surfaces require monolayer films having much lower bond strength. Useful metal and metalloid surfaces include any surface that will form a bond with compounds and preferably, form a monolayer or a substantially continuous monolayer film. Examples of suitable surfaces for forming said monolayer films include those comprising copper, nickel, chromium, zinc, silver, germanium, and alloys thereof.

The monolayer or substantially continuous monolayer film may be formed by contacting a surface with an amount of the fluorochemical benzotriazole sufficient to coat the entire surface. The compound may be dissolved in an appropriate solvent, the composition applied to the surface, and allowed to dry. Suitable solvents include ethyl acetate, 2-propanol, acetate, 2 propanol, acetone, water and mixtures thereof. Alternatively, the fluorochemical benzotriazole may be deposited onto a surface from the vapor phase. Any excess compound may be removed by rinsing the substrate with solvent and/or through use of the treated substrate.

The fluorochemical benzotriazoles not only have been found to chemically bond to metal and metalloid surfaces, they also provide, for example, release and/or corrosion inhibiting characteristics to those surfaces. These compounds are characterized as having a head group that can bond to a metallic or metalloid surface (such as a master tool) and a tail portion that is suitably different in polarity and/or functionality from a material to be released. These compounds form durable, self-assembled films that are monolayers or substantially monolayers. The fluorochemical benzotriazoles include those having the formula: 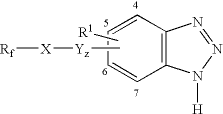
wherein R_{f} is CₙF₂ₙ₊₁—(CH₂)ₘ—, wherein n is an integer from 1 to 22 and m is 0, or an integer from 1 to 22 X is —CO₂—, —SO₃—, —CONH—, —O—, —S—, a covalent bond, —SO₂NR—, or —NR—, wherein R is H or C₁ to C₅ alkylene; Y is —CH₂— wherein z is 0 or 1; and R′ is H, lower alkyl or R_{f}—X—Y_{z}— with the provisos that when X is —S—, or —O—, m is 0, and z is 0, n is ≧7 and when X is a covalent bond, m or z is at least 1. Preferably n+m is equal to an integer from 8 to 20.

A particularly useful class of fluorochemical benzotriazole compositions for use as release agents comprising one or more compounds having the formula: 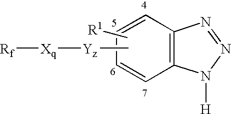
wherein R_{f} is CₙF₂ₙ₊₁—(CH₂)ₘ—, wherein n is 1 to 22, m is 0 or an integer from 1 to 22 X is —CO₂—, —SO₃—, —s—, —O—, —CONH—, a covalent bond, —SO₂NR—, or —NR—, wherein R is H or C₁ to C₅ alkylene, and q is 0 or 1; Y is C₁-C₄ alkylene, and z is 0 or 1; and R′ is H, lower alkyl, or R_{f}—X—Y_{z}. Such materials are described in U.S. Pat. No. 6,376,065.

One process may include a stretching step. For example, the article may either be uniaxially (including monoaxially) or biaxially oriented. Additionally, the process may optionally include a preconditioning step prior to stretching such as providing an oven or other apparatus. The preconditioning step may include a preheating zone and a heat soak zone. The process may also include a post conditioning step. For example, the film may be first heat set and subsequently quenched.

In general, polymers used in the articles or bodies may be crystalline, semi-crystalline, liquid crystalline or amorphous polymers or copolymers. It should be understood that in the polymer art it is generally recognized that polymers are typically not entirely crystalline, and therefore in the context of the articles or bodies, crystalline or semi-crystalline polymers refer to those polymers that are not amorphous and includes any of those materials commonly referred to as crystalline, partially crystalline, semi-crystalline, etc. Liquid crystalline polymers, sometimes also referred to as rigid-rod polymers, are understood in the art to possess some form of long-range ordering which differs from three-dimensional crystalline order.

For the articles or bodies, any polymer either melt-processable or curable into film form may be used, which can be particularly useful due to its manufacturing process, or the stability, durability, or flexibility of a final article. These may include, but are not limited to, homopolymers, copolymers, and oligomers that can be cured into polymers from the following families: polyesters (e.g., polyalkylene terephthalates (e.g., polyethylene terephthalate, polybutylene terephthalate, and poly-1,4-cyclohexanedimethylene terephthalate), polyethylene bibenzoate, polyalkylene naphthalates (e.g. polthylene naphthalate (PEN) and isomers thereof (e.g., 2,6-, 1,4-, 1,5-, 2,7-, and 2,3-PEN)) and polybutylene naphthalate (PBN) and isomers thereof), and liquid crystalline polyesters); polyarylates; polycarbonates (e.g., the polycarbonate of bisphenol A); polyamides (e.g. polyamide 6, polyamide 11, polyamide 12, polyamide 46, polyamide 66, polyamide 69, polyamide 610, and polyamide 612, aromatic polyamides and polyphthalamides); polyether-amides; polyamide-imides; polyimides (e.g., thermoplastic polyimides and polyacrylic imides); polyetherimides; polyolefins or polyalkylene polymers (e.g., polyethylenes, polypropylenes, polybutylenes, polyisobutylene, and poly(4- methyl)pentene); ionomers such as Surlyn™ (available from E. I. du Pont de Nemours & Co., Wilmington, Del.); polyvinylacetate; polyvinyl alcohol and ethylene-vinyl alcohol copolymers; polymethacrylates (e.g., polyisobutyl methacrylate, polypropylmethacrylate, polyethylmethacrylate, and polymethylmethacrylate); polyacrylates (e.g., polymethyl acrylate, polyethyl acrylate, and polybutyl acrylate); polyacrylonitrile; fluoropolymers (e.g., perfluoroalkoxy resins, polytetrafluoroethylene, polytrifluoroethylene, fluorinated ethylene-propylene copolymers, polyvinylidene fluoride, polyvinyl fluoride, polychlorotrifluoroethylene, polyethylene-co-trifluoroethylene, poly (ethylene-alt-chlorotrifluoroethylene), and THV™ (3M Co.)); chlorinated polymers (e.g., polyvinylidene chloride and polyvinylchloride); polyarylether ketones (e.g., polyetheretherketone (“PEEK”)); aliphatic polyketones (e.g., the copolymers and terpolymers of ethylene and/or propylene with carbon dioxide); polystyrenes of any tacticity (e.g., atactic polystyrene, isotactic polystyrene and syndiotactic polystyrene) and ring- or chain-substituted polystyrenes of any tacticity (e.g., syndiotactic poly-alpha-methyl styrene, and syndiotactic polydichlorostyrene); copolymers and blends of any of these styrenics (e.g., styrene-butadiene copolymers, styrene-acrylonitrile copolymers, and acrylonitrile-butadiene-styrene terpolymers); vinyl naphthalenes; polyethers (e.g., polyphenylene oxide, poly(dimethylphenylene oxide), polyethylene oxide and polyoxymethylene); cellulosics (e.g., ethyl cellulose, cellulose acetate, cellulose propionate, cellulose acetate butyrate, and cellulose nitrate); sulfur-containing polymers (e.g., polyphenylene sulfide, polysulfones, polyarylsulfones, and polyethersulfones); silicone resins; epoxy resins; elastomers (e.g, polybutadiene, polyisoprene, and neoprene), and polyurethanes. Blends or alloys of two or more polymers or copolymers may also be used.

It has been difficult to replicate surfaces using semicrystalline polymers, especially polyesters. Generally they adhere tenaciously to the tool during the replication process, unless treatments such as the fluorochemical benzotriazole coating described above are employed. As a result, they are difficult to remove from an untreated tool without causing damage to the replicated surface. Examples of semicrystalline thermoplastic polymers useful in the articles or bodies include semicrystalline polyesters. These materials include polyethylene terephthalate or polyethylene naphthalate. Polymers comprising polyethylene terephthalate or polyethylene naphthalate are found to have many desirable properties.

Suitable monomers and comonomers for use in polyesters may be of the diol or dicarboxylic acid or ester type. Dicarboxylic acid comonomers include but are not limited to terephthalic acid, isophthalic acid, phthalic acid, all isomeric naphthalenedicarboxylic acids (2,6-, 1,2-, 1,3-, 1,4-, 1,5-, 1,6-, 1,7-, 1,8-, 2,3-, 2,4-, 2,5-, 2,8-), bibenzoic acids such as 4,4′-biphenyl dicarboxylic acid and its isomers, trans-4,4′-stilbene dicarboxylic acid and its isomers, 4,4′-diphenyl ether dicarboxylic acid and its isomers, 4,4′-diphenylsulfone dicarboxylic acid and its isomers, 4,4′-benzophenone dicarboxylic acid and its isomers, halogenated aromatic dicarboxylic acids such as 2-chloroterephthalic acid and 2,5-dichloroterephthalic acid, other substituted aromatic dicarboxylic acids such as tertiary butyl isophthalic acid and sodium sulfonated isophthalic acid, cycloalkane dicarboxylic acids such as 1,4-cyclohexanedicarboxylic acid and its isomers and 2,6-decahydronaphthalene dicarboxylic acid and its isomers, bi- or multi-cyclic dicarboxylic acids (such as the various isomeric norbomane and norbomene dicarboxylic acids, adamantane dicarboxylic acids, and bicyclo-octane dicarboxylic acids), alkane dicarboxylic acids (such as sebacic acid, adipic acid, oxalic acid, malonic acid, succinic acid, glutaric acid, azelaic acid, and dodecane dicarboxylic acid.), and any of the isomeric dicarboxylic acids of the fused-ring aromatic hydrocarbons (such as indene, anthracene, pheneanthrene, benzonaphthene, fluorene and the like). Other aliphatic, aromatic, cycloalkane or cycloalkene dicarboxylic acids may be used. Alternatively, esters of any of these dicarboxylic acid monomers, such as dimethyl terephthalate, may be used in place of or in combination with the dicarboxylic acids themselves.

Suitable diol comonomers include but are not limited to linear or branched alkane diols or glycols (such as ethylene glycol, propanediols such as trimethylene glycol, butanediols such as tetramethylene glycol, pentanediols such as neopentyl glycol, hexanediols, 2,2,4-trimethyl-1,3-pentanediol and higher diols), ether glycols (such as diethylene glycol, triethylene glycol, and polyethylene glycol), chain-ester diols such as 3-hydroxy-2,2-dimethylpropyl-3-hydroxy-2,2-dimethylpropyl-3-hydroxy-2,2-di methyl propanoate, cycloalkane glycols such as 1,4-cyclohexanedimethanol and its isomers and 1,4-cyclohexanediol and its isomers, bi- or multicyclic diols (such as the various isomeric tricyclodecane dimethanols, norbornane dimethanols, norbornene dimethanols, and bicyclo-octane dimethanols), aromatic glycols (such as 1,4-benzenedimethanol and its isomers, 1,4-benzenediol and its isomers, bisphenols such as bisphenol A, 2,2′-dihydroxy biphenyl and its isomers, 4,4′-dihydroxymethyl biphenyl and its isomers, and 1,3-bis(2-hydroxyethoxy)benzene and its isomers), and lower alkyl ethers or diethers of these diols, such as dimethyl or diethyl diols. Other aliphatic, aromatic, cycloalkyl and cycloalkenyl diols may be used.

Tri- or polyfinctional comonomers, which can serve to impart a branched structure to the polyester molecules, can also be used. They may be of either the carboxylic acid, ester, hydroxy or ether types. Examples include, but are not limited to, trimellitic acid and its esters, trimethylol propane, and pentaerythritol.

Also suitable as comonomers are monomers of mixed functionality, including hydroxycarboxylic acids such as parahydroxybenzoic acid and 6-hydroxy-2-naphthalenecarboxylic acid, and their isomers, and tri- or polyfunctional comonomers of mixed functionality such as 5-hydroxyisophthalic acid and the like.

Suitable polyester copolymers include copolymers of PEN (e.g., copolymers of 2,6-, 1,4-, 1,5-, 2,7-, and/or 2,3-naphthalene dicarboxylic acid, or esters thereof, with (a) terephthalic acid, or esters thereof; (b) isophthalic acid, or esters thereof; (c) phthalic acid, or esters thereof; (d) alkane glycols; (e) cycloalkane glycols (e.g., cyclohexane dimethanol diol); (f) alkane dicarboxylic acids; and/or (g) cycloalkane dicarboxylic acids (e.g., cyclohexane dicarboxylic acid)), and copolymers of polyalkylene terephthalates (copolymers of terephthalic acid, or esters thereof, with (a) naphthalene dicarboxylic acid, or esters thereof; (b) isophthalic acid, or esters thereof; (c) phthalic acid, or esters thereof; (d) alkane glycols; (e) cycloalkane glycols (e.g., cyclohexane dimethane diol); (f) alkane dicarboxylic acids; and/or (g) cycloalkane dicarboxylic acids (e.g., cyclohexane dicarboxylic acid)). The copolyesters described may also be a blend of pellets where at least one component is a polymer based on one polyester and other component or components are other polyesters or polycarbonates, either homopolymers or copolymers.

In some embodiments of this invention, a particularly useful polymer is the product of extrusion of a polyester and a polycarbonate. It is widely believed that when polymers chosen from these two classes are extruded together, some transesterification takes place, but that transesterification is slow and unlikely to go to completion during extrusion, which would result in a truly random copolymer. Thus, polyester-polycarbonate extrusion can result in an extrudate which can range along a continuum from a two-component polymer blend to a homogeneous copolymer, but most typically results in an extrudate that has both some block copolymer character and some polymer blend character.

Variable Pitch Microstructured Birefringent Articles

A film having microstructures with a variable pitch or with features having variable angles, in certain embodiments, can have the following aspects. The film has at least two surface features made with a birefringent polymer. Each feature has a continuous cross section along a first in-plane direction (the groove direction) of the film. The cross section lies in the plane formed by a second in-plane direction (the cross-groove direction), orthogonal to the first and the normal direction to the film plane. Along any cross section, the collection of features possesses an average basal width and a distribution of basal widths varying about this average. In some embodiments, the basal width distribution among the features in the cross section is neither monotonically increasing nor monotonically decreasing.

The variable pitch of the features can include, for example, a random pitch, an aperiodic pitch, a quasi-aperiodic, or a combination of them. The pitch can be variable within first and second particular values and possibly random within those values. The surface opposite the structured surface in an article may be flat, smooth, rough, structured, or have other types of topography. Some embodiments can use, with the article or film, retarders, wave plates, multilayer optical films, IR filters, circular polarizers or all of these items together. Furthermore, an advantage of variable pitch microstructured articles lies in their ability to hide small defects in the film. This advantage can lead to considerable improvements in the manufacturing yield.

When the cross section varies for a given feature along the groove direction, the extent of that variation, e.g. in pitch, angle, height or depth, as well as the rate of change of that extent may play a role in the quality and function of the process and/or article. For example, the level of shape fidelity upon forming the structure or the quality of shape retention or even film integrity may vary. The effects of these factors on the suitability needs to be considered in the context of the desired use.

The relative position of the surface features determines the pattern of constructive and destructive interference for light passing through the film. In many instances it is desirable to minimize the effects of interference by randomly varying the relative positions of the surface features. The features can be contiguous, i.e. touching, across a specified length scale, e.g. 0.5 mm. The material in the features or on the back side of the land, when the materials are the same, can have a low level of relative birefringence. Along the first in-plane direction, the cross section of the collection of features can possess an average basal width and a distribution of basal widths varying about this average that remain essentially fixed. The collection of feature cross sections can vary along the first in-plane direction. The features can have similar shapes, possibly with different dimensions (e.g., right-triangle shapes of varying height but common apex angles). Alternatively, the features can have dissimilar shapes.

A process for forming the film having variable pitch microstructures can involve at least two steps. First, at least three surface features are formed consistent with the aspects identified above. Second, the film is stretched along the first in-plane direction of the film.

The process can alternatively involve the following additional aspects. The average basal width after stretching can be less than the initial basal width prior to stretching. The stretching can cause the polymer to become birefringent inside at least three surface features. The stretching process can be truly uniaxial and thereby maintain a high level of shape retention for the surface features and a low level of relative birefringence.

It is often advantageous to maintain the general shape of the surface features, e.g. apex angle and inclination of the sides relative to the film plane, along the cross section. For example, in a blur filter application, the slant of the inclined surface of the sawtooth and its nearly vertical side wall directly impact the relative divergence of the light in the two orthogonal states of polarization. The process of stretching reduces the dimensions of a typical surface feature. However, some forms of stretching (e.g., truly uniaxial stretching) essentially maintain the shape of individual surface features. For example, a surface feature that is approximately a right triangle remains essentially a right triangle after stretching. Although linear dimensions of surface features change during uniaxial stretching, angular features of the structures are essentially retained. In certain embodiments, the film can be stretched, structured, and then stretched again.

Quasi-aperiodic features may be used generally in the method of the present invention. Such features may be formed on the surface of a polymeric cast film or web. The film may be stretched (drawn) along the groove direction (or average groove direction in the case of variable cross-sectioned features) with or without orientation resulting from the stretching. Alternatively, such features may be formed on a pre-oriented polymeric film.

The particular optical performance of films possessing birefringent quasi-aperiodic surface features can be achieved through a variety of strategies. In one method, an aperiodic progression of pitch, i.e. the progression of basal width, can be chosen to break up the constructive and destructive interference extremes. A pattern can be chosen deliberately to avoid common factors among the spacings of the various features. In another method, the pattern can be chosen by a randomizing algorithm chosen to conform to an expected mean with a predetermined distribution of basal width. In another method, the pattern can be formed by a process that randomly changes in the depth of cutting due to a diamond turning plunging method, for example. An example of a method of diamond turning is described in U.S. Pat. No. 6,354,709, which is incorporated herein by reference as if fully set forth. Alternative processes include extrusion, replication onto a sheet, extrusion into a nip with rollers, embossing and molding.

In these manners, an array of quasi-aperiodic structures can be formed that have either a constant cross section for the collection of features along the groove direction (i.e., each particular feature in the collection has a uniform, constant cross-sectional size and shape as one proceeds down the groove direction), or a variable cross section for the collection of features along the groove direction (i.e., each particular feature in the collection has a changing cross-sectional size or shape as one proceeds down the groove direction).

The articles can optionally include, but do not require, index matching material or fluid on one or more surfaces of the articles or between the articles. They can also optionally be laminated or adhered to a sealing plate such as, for example, glass, plexiglass, or plastic. The articles can be made from, for example, those materials described above and in the Examples using the process shown in and described with respect to FIG. 4.

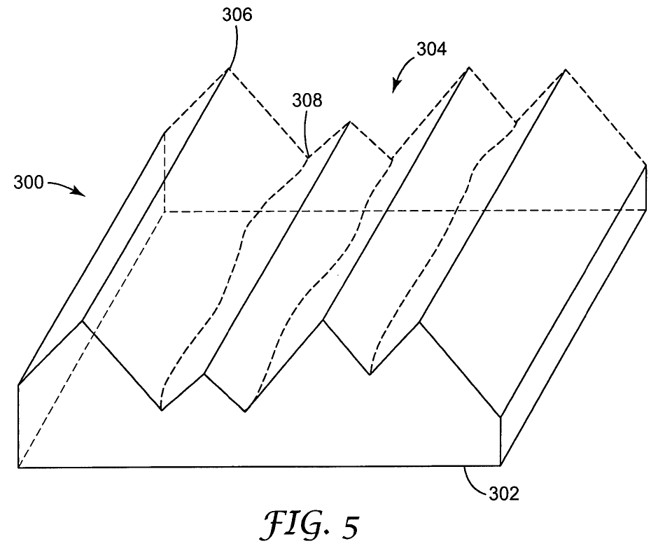

Examples of variable pitch microstructured films are shown in FIGS. 5, 6A, 6B, 7A, 7B, 8A, and 8B. In these Figures, the land z and amplitude in the side views, and the variations along the groove direction and gradient in the top views, are not to scale. (An example of a film having features with variable angles is shown in FIG. 2E.) FIG. 5 is a perspective view of a section of a variable pitch microstructured birefringent film with a fixed PS. Film 300 has a structured surface 304 and an opposing surface 302. Unlike the films with periodic structures (as in FIGS. 2A or 2B, for example), the peaks (e.g, peak 306) of film 300 do not form a straight line parallel to the first in-plane axis. Instead, the heights of the peaks of the prisms shown in FIG. 15 are allowed to vary continuously along their lengths. Similarly, the depths of the valleys (e.g., valley 308) are also allowed to vary continuously.

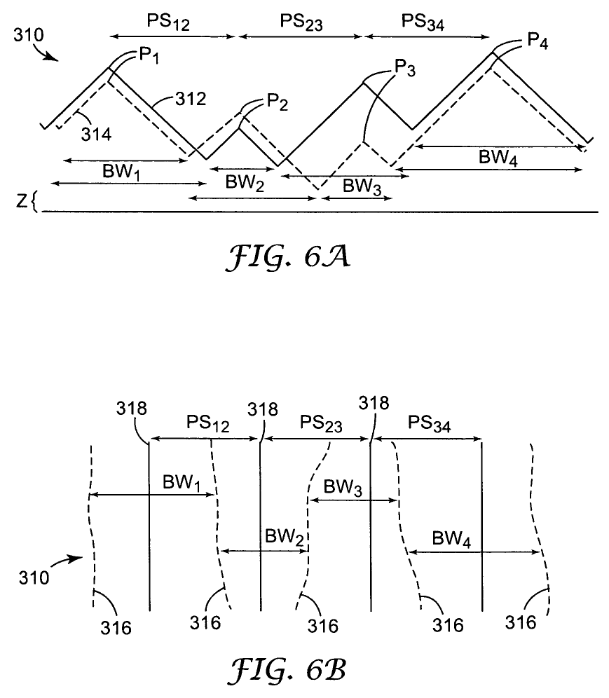

FIGS. 6A and 6B are side and top views, respectively, of a section of a variable pitch microstructured birefringent film 310 having a constant PS and a variable BW. In FIG. 6A, the side view of film 310 is shown with cross sections 312 and 314 at two locations along the groove direction. Film 310 has a constant PS, as shown by the substantially same distances represented by PS₁₂, PS₂₃, and PS₃₄, where PS_{xy} is the distance between peaks Pₓ and P_{y} Also, film 310 has a variable BW, as shown by the different distances represented by BW₁, BW₂, and BW₃, where BWₓ is the distance between the valleys of peak Pₓ. In FIG. 6B, the top view of film 310 illustrates the projected peak contours 318 and valley contours 316.

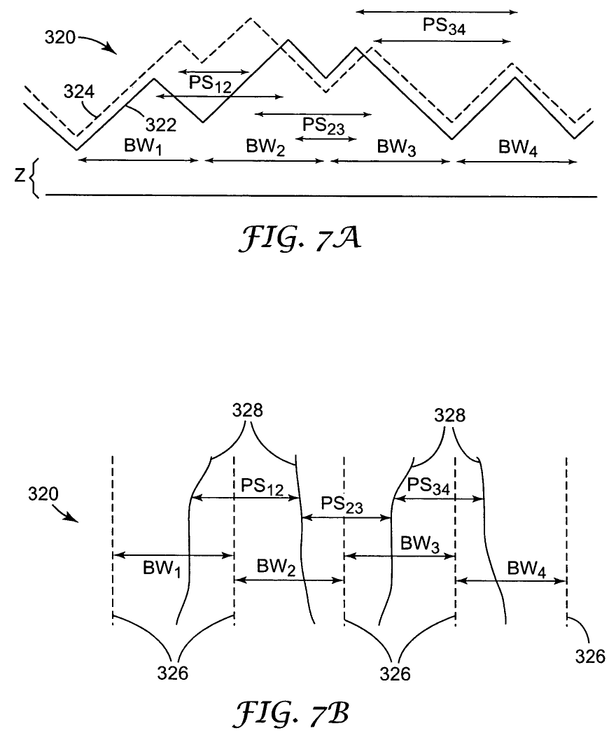

FIGS. 7A and 7B are side and top views, respectively, of a section of a variable pitch microstructured birefringent film 320 having a variable PS and a constant BW. In FIG. 7A, the side view of film 320 is shown with cross sections 322 and 324 at two locations along the groove direction. Film 320 has a variable PS, as shown by the different distances represented by PS₁₂, PS₂₃, and PS₃₄, and it has a constant BW, as shown by the substantially same distances represented by BW₁, BW₂, and BW₃. In FIG. 7B, the top view of film 320 illustrates the projected peak contours 328 and valley contours 326.

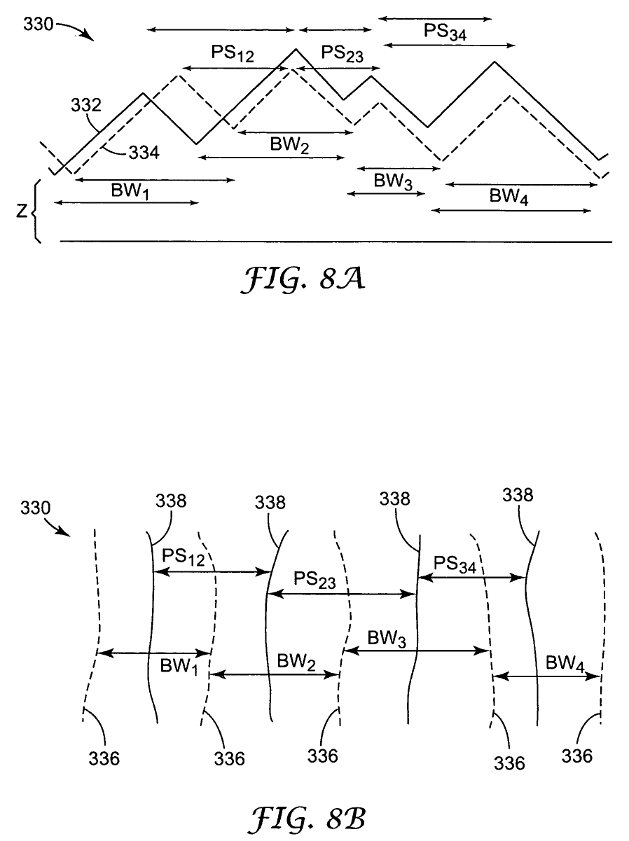

FIGS. 8A and 8B are side and top views, respectively, of a section of a variable pitch microstructured birefringent film 330 having a variable PS and a variable BW. In FIG. 8A, the side view of film 330 is shown with cross sections 332 and 334 at two locations along the groove direction. Film 330 has a variable PS, as shown by the different distances represented by PS₁₂, PS₂₃, and PS₃₄, and it also has a variable BW, as shown by the different distances represented by BW₁, BW₂, and BW₃. In FIG. 8B, the top view of film 330 illustrates the projected peak contours 338 and valley contours 336.

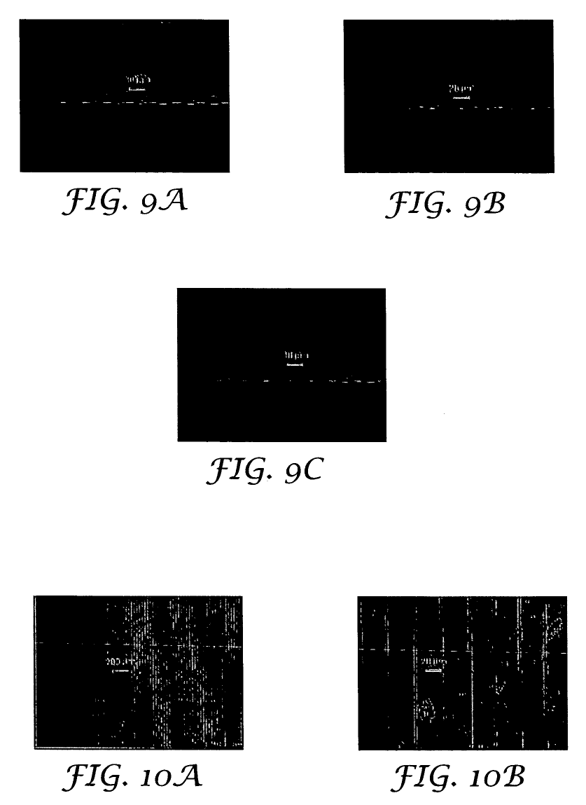

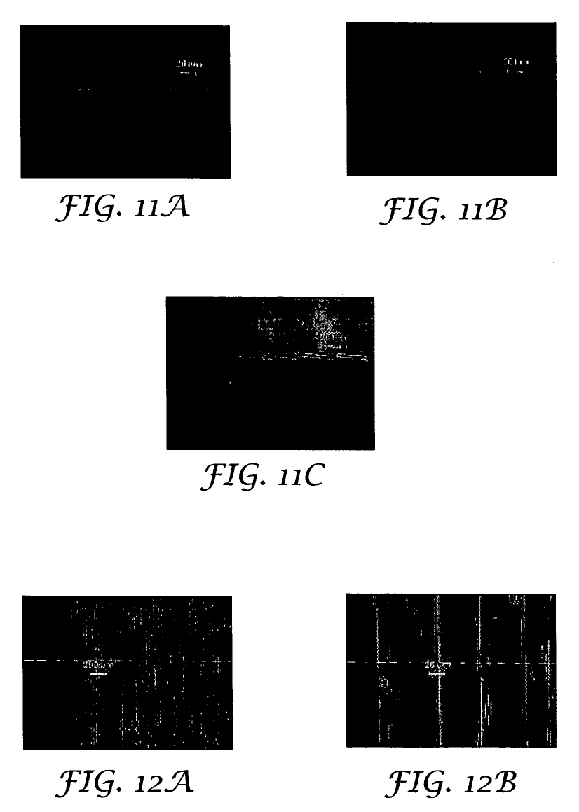

FIGS. 9-12 are images of samples illustrating 10% and 100% random pitch. FIGS. 9A-9C and 10A-10B are edge views and top views, respectively, of SEM images of an exemplary sample having 10% random pitch. FIGS. 11A-11C and 12A-12B are edge views and top views, respectively, of SEM images of an exemplary sample having 100% random pitch.

Films made in accordance with the present invention may be useful for a wide variety of products including tire cordage, filtration media, tape backings, wipes such as skin wipes, microfluidic films, blur filters, polarizers, reflective polarizers, dichroic polarizers, aligned reflective/dichroic polarizers, absorbing polarizers, retarders (including z-axis retarders), diffraction gratings, polarizing beam splitters and polarizing diffraction gratings. The films may comprise the particular element itself or they can be used as a component in another element such as a tire, a filter, an adhesive tape, beamsplitters e.g., for front and rear projection systems, or as a brightness enhancement film used in a display or microdisplay.

In the above description, the position of elements has sometimes been described in terms of “first”, “second”, “third”, “top” and “bottom”. These terms have been used merely to simplify the description of the various elements of the invention, such as those illustrated in the drawings. They should not be understood to place any limitations on the useful orientation of the elements of the present invention. Also, as an alternative to the use of axes, the positioning of a single article, or of multiple articles used together, can be described in terms of their Euler angles.

Accordingly, the present invention should not be considered limited to the particular examples described above, but rather should be understood to cover all aspects of the invention as fairly set out in the claims. Various modifications, equivalents, as well as numerous structures to which the present invention may be applicable will be readily apparent to those of skill in the art to which the present invention is directed upon review of the present specification. The claims are intended to cover such modifications and devices.

### EXAMPLES

### Example 1

### Creation of Oriented Microstructured Film

A polyethylene terephthalate (PET) with an inherent viscosity (I.V.) of 0.74 available from Eastman Chemical Company, Kingsport, Tenn. was used in this example.

The PET pellets were dried to remove residual water and loaded into an extruder hopper under a nitrogen purge. The PET was extruded with an increasing temperature profile of 232° C. to 282° C. within the extruder and the continuing melt train through to the die set at 282° C. Melt train pressures were continuously monitored and an average taken at the final monitored position along the melt train prior to bringing the die into close proximity to the tool onto which the polymer film is formed simultaneously with the structuring of a first surface of that film against the tool.

The tool was a structured belt Nickel alloy specific composition unknown, made at 3M, electroformed, welded sections having a negative version of the structured surface formed on the cast film. The structured surface comprised a repeating and continuous series of triangular prisms. The triangles formed a sawtooth-like pattern. The basal vertices of the individual prisms were shared by their adjoining, neighboring structures. The prisms were aligned along the casting or machine direction (MD) direction. The structured surface of the tool was coated with a fluorochemical benzotriazole having the formula 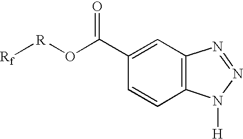
where R_{f} is C₈F₁₇ and R is —(CH₂)₂—, as disclosed in U.S. Pat. No. 6,376,065. The tool was mounted on a temperature-controlled rotating can which provided a continuous motion of the tool surface along the casting (MD) direction. The measured surface temperature of the tool averaged 92° C.

The die orifice through which the molten polymer exited the melt train was brought into close proximity with the rotating belt tool forming a final slot between the tool and die. The pressure at the final monitored position along the melt train increased as the die and tool became closer. The difference between this final pressure and the previously recorded pressure is referred to as the slot pressure drop. The slot pressure drop in this example was 7.37×10⁶ Pa (1070 psi) providing sufficient pressure to drive the molten polymer into the structured cavities formed by the tool negative. The film thereby formed and structured was conveyed by the tool rotation from the slot, quenched with additional air cooling, stripped from the tool and wound into a roll. Including the height of the structures, the total thickness of the cast film (T) was about 510 microns.

The cast and wound polymer film closely replicated the tool structure. Using a microscope to view the cross section, a prismatic structure was identified on the surface of the film with an approximately 85° apex angle, 200 inclination from the horizontal of the film land for one leg of the triangle and a 15° tilt from the perpendicular for the opposite leg. The measured profile exhibited the expected, nearly right triangular form with straight edges and a slightly rounded apex. The replicated prisms on the polymeric film surface were measured to have a basal width of 44 microns and a height (P) of 19 microns. The peak-to-peak spacing (PS) was approximately the same as the basal width. The film was imperfect and there were small variations from nominal sizing owing to tooling defects, replication process defects, and thermal shrinkage effects.

The structured cast film was cut into sheets with an aspect ratio of 10:7 (along the grooves:perpendicular to grooves), preheated to about 100° C. as measured in the plenums of the tenter, stretched to a nominal stretch ratio of 6.4 and immediately relaxed to a stretch ratio of 6.3 in a nearly truly uniaxial manner along the continuous length direction of the prisms using a batch tenter process. The relaxation from 6.4 to 6.3 was accomplished at the stretch temperature to control shrinkage in the final film. The structured surfaces maintained a prismatic shape with reasonably straight cross-sectional edges (reasonably flat facets) and approximately similar shape. The basal width after stretch was measured by microscopy cross-sectioning to be 16.5 microns and the peak height after stretch (P′) was measured to be 5.0 microns. The final thickness of the film (T′), including the structured height, was measured to be 180 microns. The indices of refraction were measured on the backside of the stretched film using a Metricon Prism Coupler as available from Metricon, Piscataway, N.J., at a wavelength of 632.8 nm. The indices along the first in-plane (along the prisms), second in-plane (across the prisms) and in the thickness direction were measured to be 1.672, 1.549 and 1.547 respectively. The relative birefringence in the cross-sectional plane of this stretched material was thus 0.016.

When placed within an optical path, the film provided for a shifting (double) image that shifted markedly in response to the rotation of a polarizer held between the film and a viewer.

Although this example describes the creation of a film with periodic structures, the same methods and procedures apply to create a film with aperiodic structures. As the breadth of the probability distribution for the random pitches increases beyond a particular value, based for example upon empirical evidence, it may be necessary to modify the procedures.

### Example 2

### Variable Pitch Article

Sample Preparation

The tooling was cut by diamond turning copper sheeting on a 3M Pneumo. No oil or liquid cooling was used. The diamond used had an 84 degree included angle and was held so as to yield a cut with a 6 degree angle off of horizontal with a vertical facet sidewall. The cut tool was treated with BTA. The polymer films were then embossed in a compression molding machine. The process conditions varied depending upon the material being molded. Conditions were chosen such that high fidelity replication was achieved while avoiding crystallization induced haze. If a sample displayed haze that was discernible to the eye that sample was discarded. Sometimes it was found to be helpful to use an ice bath to rapidly cool the film.

Samples were then cut to size and uniaxially oriented in either a commercial lab scale batch tentering machine. Draw conditions varied depending upon the material, the thickness, and the target birefringence. The stretched samples were then tested for refractive index through measuring the back side properties on a Metricon. Geometric structural features on the active face were measured by profilometry. Other geometric features such as peak tip sharpness and valley sharpness were measured by cross-sectioning and examination under SEM or optical microscopy.

What is claimed:

1. A structured article, comprising:
(a) a body having (i) first and second surfaces, and (ii) first and second in-plane axes that are orthogonal with respect to each other and a third axis that is mutually orthogonal to the first and second in-plane axes in a thickness direction of the body; and
(b) a portion of the first surface being a birefringent structured surface having a variable pitch.

2. The article of claim 1, wherein the variable pitch comprises a random pitch, an aperiodic pitch, or a quasi-aperiodic pitch.

3. The article of claim 1, wherein the pitch varies with first and second particular values.

4. The article of claim 1 wherein the structured surface has a geometric a micro-feature.

5. A uniaxially oriented structured article comprising:
(a) a polymeric film having (i) a first and a second surface, and (ii) first and second in-plane axes that are orthogonal with respect to each other and a third axis that is mutually orthogonal to the first and second in-plane axis in a thickness direction of the polymeric film; and
(b) a surface portion comprising a plurality of geometric features disposed on the first surface of the polymeric film, the plurality of geometric features being disposed on the film in a direction substantially parallel to the first in-plane axis of the polymeric film,
wherein the plurality of geometric features have a variable pitch.

6. The article of claim 5, wherein the variable pitch comprises a random pitch, an aperiodic pitch, or a quasi-aperiodic pitch.

7. The article of claim 5 wherein the uniaxially oriented polymeric film has (i) a first index of refraction (n₁) along the first in-plane axis, (ii) a second index of refraction (n₂) along the second in-plane axis, and (iii) a third index of refraction (n₃) along the third axis, wherein n₁≠n₂ and n₁≠n₃ and n₂ and n₃ are substantially equal to one another relative to their differences with n₁.

8. The article of claim 5 wherein the film comprises a multilayer film having a plurality of layers of different polymeric composition.

9. The article of claim 5 wherein the geometric features comprise micro-features.

10. A structured article, comprising:
(a) a body having (i) first and second surfaces, and (ii) first and second in-plane axes that are orthogonal with respect to each other and a third axis that is mutually orthogonal to the first and second in-plane axes in a thickness direction of the body; and
(b) a portion of the first surface having features with variable angles.

11. The article of claim 10 wherein the structured surface has at least two different geometric micro-features.

12. A method of making a structured article, comprising the steps of:
(a) providing a body having (i) first and second surfaces, and (ii) first and second in-plane axes that are orthogonal with respect to each other and a third axis that is mutually orthogonal to the first and second in-plane axes in a thickness direction of the body; and
(b) forming a birefringent structured surface having a variable pitch on a portion of the first surface.

13. The method of claim 12, wherein the forming step includes forming the article to be biaxially oriented.

14. The method of claim 12, wherein the forming step comprises forming a random pitch, an aperiodic pitch, or a quasi-aperiodic pitch.

15. The method of claim 12, wherein the forming step includes stretching the body in a direction substantially parallel to the first in-plane axis.

16. The method of claim 15 wherein the polymeric film is substantially unstretched prior to step (b).

17. The method of claim 12 wherein the body comprises a plurality of layers.

18. The method of claim 12 wherein the structured surface comprises at least one micro-feature.

19. A method of making having a structured surface polymeric film comprising the steps of:
(a) providing a polymeric film having (i) a first structured and a second surface, and (ii) first and second in-plane axes that are orthogonal with respect to each other and a third axis that is mutually orthogonal to the first and second in-plane axis in a thickness direction of the polymeric film, wherein the first structured surface comprises a plurality of geometric features being disposed on the film in a direction substantially parallel to the first in-plane axis of the polymeric film; and subsequently
(b) stretching the structured surface polymeric film in a direction substantially parallel to the first in-plane axis of the polymeric film,
wherein the plurality of linear geometric features have a variable pitch.

20. The method of claim 19, wherein the cross-sectional shape of the plurality of geometric features before step (b) are substantially retained after step (b).

21. The method of claim 19, wherein the stretching step includes forming the film to be truly uniaxial.

22. The method of claim 19 wherein the polymeric film is substantially unstretched prior to step (b).

23. The method of claim 19 wherein the polymeric film is substantially unoriented prior to step (b).

24. The method of claim 19 wherein the polymeric film is birefringent after step (b).

25. The method of claim 19 wherein the structured surface polymeric film comprises a plurality of layers.

26. The method of claim 19 wherein the structured surface comprises at least two different micro-features.
